(19) United States
(12) Patent Application Publication
(10) Pub. No.: US 2021/0329923 A1
(43) Pub. Date: Oct. 28, 2021

(54) BOWLING BALL HOLE ANTIMICROBIAL WIPES

(71) Applicant: Charles V. Kinstler, Laguna Beach, CA (US)

(72) Inventor: Charles V. Kinstler, Laguna Beach, CA (US)

(21) Appl. No.: 17/240,762

(22) Filed: Apr. 26, 2021

Related U.S. Application Data
(60) Provisional application No. 63/016,115, filed on Apr. 27, 2020.

(51) Int. Cl. A01N 59/08; A63D 5/10; A01N 31/02; C11D 17/04; C11D 11/00; C11D 3/48; A01N 25/34

(52) U.S. Cl. CPC A01N 59/08; A63D 5/10; A01N 31/02; A01N 25/34; C11D 11/0023; C11D 3/48; C11D 17/049

(57) ABSTRACT

Various antimicrobial hole wipes for bowling balls are disclosed. The hole wipe can be configured for use in sanitizing, disinfecting, or otherwise cleaning, the holes in a bowling ball. The hole wipe can comprise a body with an opening on an end that is configured to receive a user's finger. The hole wipe can be impregnated with an antimicrobial agent, such as an alcohol solution. The user can place the hole wipe on his or her finger and then place the hole wipe into the hole to treat substantially the entire surface area within the hole. The user can withdraw his or her finger and then remove and discard the hole wipe.

This application claims the priority benefit of U.S. Patent Application No. 63/016,115, filed Apr. 27, 2020, the entirety of which is incorporated by reference herein.

### BACKGROUND

### Field

This disclosure relates to antimicrobial wipes for blind holes, such as wipes that are configured to clean, sanitize, and/or disinfect the finger holes in a bowling ball.

### Certain Related Art

The game of bowling (ten-pin bowling) is one of the world's most popular activities. The game involves propelling a ball down a lane toward a set of ten pins, with the goal of knocking over the pins using at most two throws of the ball. To aid players in propelling and controlling the ball, the ball includes holes that can receive a player's fingers and/or thumb. Some balls have one hole (e.g., for one finger or a thumb), some have two holes (e.g., for a thumb and one finger or two fingers), and some have three holes (e.g., for a thumb and two fingers). The holes are blind holes in the ball. Each of the blind holes can be called a “finger hole,” regardless of whether a specific blind hole is intended to receive a finger or a thumb.

### SUMMARY OF CERTAIN FEATURES

This disclosure relates to cleaning wipes for blind holes, such as wipes that are configured to wash, sanitize, and/or disinfect the finger holes in a bowling ball or other article. This can be beneficial in enhancing cleanliness and/or reducing the transmission of disease.

Some bowling balls are shared among users. For example, a bowling alley or other establishment may have a collection of bowling balls available for patrons to select from and use. During use, the patron handles the ball, which typically includes inserting his or her fingers and/or thumb into the holes. As a result, dirt, residue, oils, and/or microbes (e.g., viruses and bacteria) on the patron's hands can be transferred to the ball, including the surface area inside the holes. When the patron is finished using the ball, he or she can return the (now contaminated) ball to a storage area for the shared balls, at which point another patron may select the ball for use. This can provide a vector for transmission of the microbes.

In some cases, the balls are cleaned after use. For example, the ball may be wiped with a cleaning sheet (e.g., a flat rectangle of fibrous material that includes a cleaning agent). However, this approach is ineffective in cleaning the holes. The cleaning sheet typically gets bunched and bound around the opening of the hole, thereby inhibiting access to portions or the surface area of the hole, such as the bottom of the hole. This can result in a portion of the hole remaining contaminated.

It would be beneficial to have a wipe that is adapted for ready use in treating (e.g., sanitizing and/or disinfecting) the holes in a bowling ball. It would be advantageous for the wipe to be wearable on a user's finger and to be convenient to apply and remove. Preferably, the wipe could be inserted into the holes (e.g., while on the user's finger) and be moved within the hole to contact substantially the entire inner surface of the hole, such as the sidewalls and the bottom.

In certain embodiments, an antimicrobial bowling ball hole wipe includes a body. The body can be tubular and/or elongate. The body can be hollow. The body can include a first side and a second side opposite the first side. The sides can be joined, such as by pressing, welding, heating, etc. The sides can be connected with one or more fabric staples. In some implementations, the sides are unitarily formed. The body can include an open end and a closed end opposite the open end. The body can include an antimicrobial agent. The hole wipe can be configured to be inserted on a user's finger and to be inserted into a blind hold of a bowling ball. This can enable a bottom surface of the hole to be cleaned of microbes, dirt, and/or other contaminants.

In some embodiments, the antimicrobial agent comprises at least 70% alcohol and/or bleach. In certain implementations, the first side comprises an insertion aid. For example, the insertion aid can be a recess. The insertion aid can be adjacent the open end. In some variants, the insertion aid comprises a flap. The flap can have a free end. The wipe can include an insertion and removal aid, such as a tab. The tab can extend from the open end.

The wipe can include a retaining element, such as an elastic ring. The ring can be adjacent the open end. The wipe can include a seam on the closed end. The body of the wipe can have a longitudinal seam. In certain embodiments, the first side and the second side are joined along a top and a bottom and along the closed end. In some implementations, the wipe is individually packaged in an outer tear pouch. The wipe can be included in a kit. The kit can include the wipe of and a pair of bowling shoes or other articles.

The body can be made of a material configured to absorb the antimicrobial agent. For example, the body can be made of cotton. The body can comprise a barrier layer (e.g., non-liquid permeable) and an absorbent layer (liquid permeable).

In some implementations, the wipe comprises a flat sheet. The flat sheet can include a central hub and a plurality of arms connected to the central hub and extending radially outward from the central hub, and a plurality of gaps. In some variants, each of the plurality of gaps are located between respective circumferentially-adjacent arms of the plurality of arms. The wipe can include an antimicrobial agent. The wipe can be configured to be inserted on a user's finger and to be inserted into a blind hold of a bowling ball. The hub can include a concavity configured to receive a tip of the finger. The antimicrobial agent can be at least 70% alcohol.

In certain embodiments, a method of manufacturing an antimicrobial bowling ball hole wipe includes rolling a flat sheet of material into a tubular element in which a first lateral edge overlaps a second lateral edge. The method can include cutting the tubular element into a plurality of tubes. The method can include closing a first end of each of the plurality of tubes, such as with stitching, heat sealing, welding, etc. The method can include keeping open a second end of each of the plurality of tubes, the second end opposite the first end. The method can include applying an antimicrobial agent to each of the plurality of tubes. The method can include individually packaging each of the plurality of tubes.

Certain aspects, advantages, and features of the technology have been described above for the purpose of summarizing certain aspects of the technology disclosed herein. Not necessarily any or all such advantages are achieved in accordance with any particular embodiment of the technology. Neither the preceding summary nor the following detailed description purports to limit or define the scope of protection. The scope of protection is defined by the claims.

### BRIEF DESCRIPTION OF THE DRAWINGS

Various embodiments are depicted in the accompanying drawings for illustrative purposes, and should not be interpreted as limiting the scope of the embodiments. Various features of different disclosed embodiments can be combined to form additional embodiments, which are part of this disclosure.

FIG. 1 illustrates a system comprising a bowling ball and a wipe.

FIG. 2A illustrates a side view of an embodiment of a wipe.

FIG. 2B illustrates a front view of the wipe of FIG. 2A.

FIG. 3A illustrates a side view of another embodiment of a wipe.

FIG. 3B illustrates a front view of the wipe of FIG. 3A.

FIG. 4A illustrates a side view of another embodiment of a wipe.

FIG. 4B illustrates a cross-sectional view of the wipe of FIG. 4A.

FIG. 5A illustrates a side view of another embodiment of a wipe.

FIG. 5B illustrates a front view of the wipe of FIG. 5A.

FIG. 6 illustrates a front view of another embodiment of a wipe.

FIG. 7A illustrates a perspective view of another embodiment of a wipe.

FIG. 7B illustrates a cross-sectional view of the wipe of FIG. 7A.

FIG. 8 illustrates a perspective view of a wipe stick.

FIG. 9 illustrates a unit comprising multiple wipes.

### DETAILED DESCRIPTION OF CERTAIN EMBODIMENTS

Various cleaning (e.g., antimicrobial) wipes for blind holes and methods are described below to illustrate various examples that may achieve one or more desired improvements. These examples are only illustrative and not intended in any way to restrict the general disclosure presented and the various aspects and features of this disclosure. The embodiments are disclosed in the context of wipes for bowling ball finger holes, due to particular utility in that context. However, the technology disclosed herein is not limited to only that context; on the contrary, the technology can be used in a wide variety of contexts in which it is desirable to clean a blind hole. For example, the technology can be used to clean finger holes in shared gloves or equipment that receives a user's finger. The general principles described herein may be applied to embodiments and applications other than those discussed herein without departing from the spirit and scope of the disclosure. Indeed, this disclosure is not limited to the particular embodiments shown, but is instead to be accorded the widest scope consistent with the principles and features that are disclosed or suggested herein.

Although certain aspects, advantages, and features are described herein, it is not necessary that any particular embodiment include or achieve any or all of those aspects, advantages, and features. Some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable.

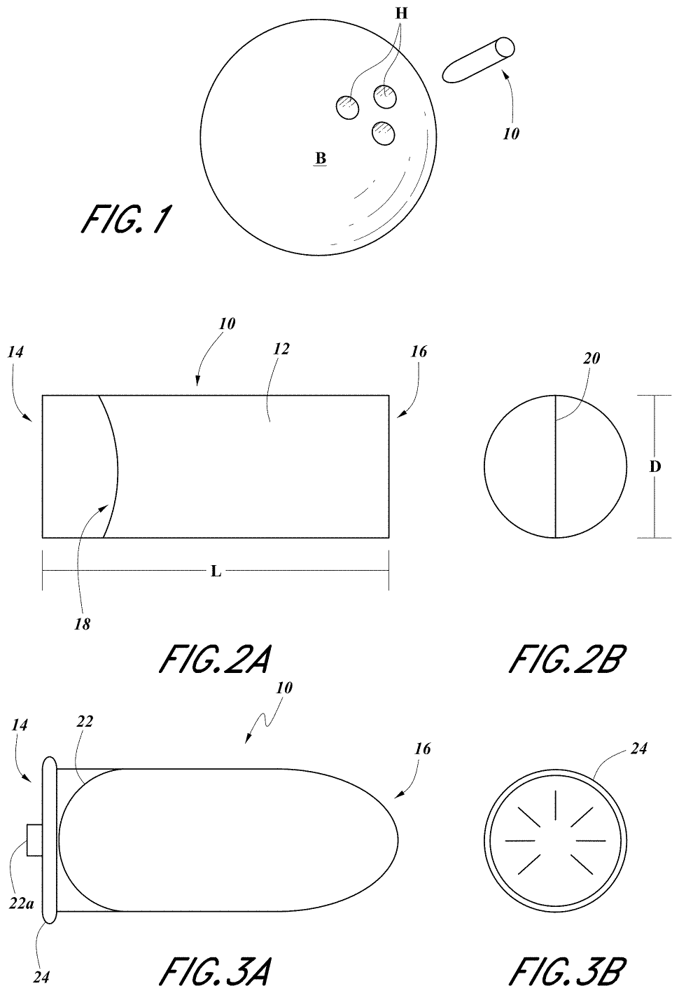

### FIG. 1

FIG. 1 illustrates an example of a bowling ball B and a hole wipe 10. As shown, the ball B includes holes H that can receive one of the user's fingers or thumb. The holes can be blind holes that are drilled into the ball or can be formed with the ball, such as during a molding process. The holes can have a sidewall and a bottom. As discussed in more detail below, the hole wipe 10 can receive a user's finger, can include an antimicrobial agent, and can be adapted for ready insertion into, and removal from, the holes. This can enable the hole wipe 10 to treat the inner surface of the holes, thereby reducing the risk of the transmission of microbes. In certain embodiments, the wipe 10 includes a cleaning agent, such as soap or detergent. In several implementations, the wipe 10 is disposable and/or is configured for a single use. For example, the wipe 10 can be adapted for cleaning the finger holes of a single bowling ball. In some embodiments, one wipe 10 has sufficient antimicrobial agent to sanitize and/or disinfect one, two, or three finger holes.

### FIGS. 2A and 2B

FIGS. 2A and 2B illustrate an example of the hole wipe 10. FIG. 2A is a side view of the hole wipe 10 and FIG. 2B is a front view of the hole wipe 10. The hole wipe 10 can be adapted to fit on a user's finger, such as the index finger. For example, the hole wipe 10 can comprise a hollow tubular shape that is large enough to receive a finger. As shown, from a side view, the hole wipe 10 can have a generally rectangular shape. In some variants, the hole wipe 10 has other shapes, such as rounded, tapered, conical, frustoconical, or otherwise. From a front view, the hole wipe 10 can be generally circular, oval, or other shapes. In various embodiments, the wipe 10 can be packaged in a flat and/or folded configuration and can be configured to be opened into the hollow shape for use.

The hole wipe 10 can include a body 12, an open end 14, and a closed end 16. The hole wipe 10 can have an inner chamber that is configured to receive the user's finger. The hole wipe 10 can include first and second sides. The sides can be joined, such as by pressing, welding, heating, etc. The sides can be connected with one or more fabric staples. In some implementations, the sides are unitarily formed.

The open end 14 can be adapted to aid the user in applying the hole wipe 10 onto the finger. For example, the open end 14 can have an insertion aid, such as a concave region or recess 18. The recess 18 can help the user in separating sides of the hole wipe 10 and/or in inserting a finger into the hole wipe 10. For example, the recess 18 can aid a user in slipping a finger between the sides of the wipe 10, such as may be otherwise difficult if the wipe 10 is packaged flat and/or not opened up to form the inner chamber. The recess 18 can be straight, curved, or otherwise shaped (e.g., zig-zag).

The closed 16 end can be configured to receive a user's fingertip and/or to fit closely (e.g., flush) with the fingertip. The fingertip can be used to press on the closed end 16 to push the wipe 10 into the hole. The closed end 16 can be tapered (e.g., generally conical), flat (e.g., generally planar), pleated, or otherwise shaped. In some embodiments, the closed end 16 does not include a reservoir tip. The taper can be rounded, linear, or otherwise. Some variants do not have a closed end and/or have multiple open ends. In some implementations, the closed end 16 includes a seam 20. Certain variants do not have the seam 20 on the closed end 16 and/or have a closed end 16 that is continuous (e.g., uninterrupted).

The hole wipe 10 can be sized for use with a variety of sizes of fingers and/or holes. For example, the hole wipe 10 can have a length L of greater than or equal to about: 2.0 inches, 2.5 inches, 3.0 inches, 3.5 inches, 4.0 inches, or otherwise. The hole wipe 10 can have a diameter D (or side-to-side distance) of greater than or equal to about: ⅜ inch, ½ inch, ⅝ inch, ¾ inch, ⅞ inch, or otherwise. In certain implementations, the ratio of L to D is at least approximately: 4, 5, 6, 7, or otherwise. In some variants, the hole wipe 10 is configured such that, when worn, the open end 14 extends to or beyond a user's first knuckle (e.g., the joint between the distal phalanx and middle phalanx). In several embodiments, the hole wipe 10 is configured such that, when worn, the open end 14 extends to or beyond a user's second knuckle (e.g., the joint between the middle phalanx and proximal phalanx). The hole wipe 10 can be sized so that, when worn, the open end 14 is positioned on the user's finger. Various implementations of the hole wipe 10 do not contact, extend over, and/or cover the user's palm when worn. Other embodiments contact, extend over, and/or cover the user's palm when worn. During use, the closed 16 end can be in contact with, or spaced apart from, the tip of the user's finger.

The hole wipe 10 can include a cleaning agent, such as an antimicrobial agent. For example, the material of the hole wipe 10 can be impregnated with, coated with, and/or be saturated with the antimicrobial or other cleaning agent. The antimicrobial agent can be a sanitizer and/or disinfectant. In some embodiments, the antimicrobial agent comprises ethanol alcohol, isopropanol alcohol, or another alcohol compound. For example, the antimicrobial agent can comprise at least about 70% alcohol. In some embodiments, the antimicrobial agent comprises an antimicrobial ammonium compound, such as alkyl dimethyl benzyl ammonium chloride. In certain implementations, the antimicrobial agent comprises bleach. The antimicrobial agent can be a liquid. The antimicrobial agent can be soluble in water. In some embodiments, the cleaning agent comprises liquid soap, detergent, ammonia, or other compounds.

The hole wipe 10 can be made of an absorbent material. The absorbent material can be configured to retain the antimicrobial or otherwise cleaning agent during storage of the hole wipe 10 and/or to dispense the antimicrobial or otherwise cleaning agent to the inner surface of the hole during use. The hole wipe 10 can be made of a natural fiber (e.g., cotton) or a synthetic fiber (e.g., plastic). Certain embodiments comprise cotton, wool, cellulose, spunlace, paper, polyester, gauze, nylon, combinations of any of the aforementioned, or otherwise. In some embodiments, the hole wipe 10 comprises a base material (e.g., cellulose) and a reinforcing material (e.g., a polymer). In some implementations, the wipe 10 comprises latex, nitrile rubber, polyvinyl chloride, neoprene, or otherwise. The hole wipe 10 can comprise a woven or non-woven material. In certain variants, the wipe 10 comprises a composite. The composite can comprise a combination of any of the materials described herein. In some embodiments, the composite comprises plastic coated paper. The plastic coating can be, for example, low density polyethylene (LDPE) or polyethylene terephthalate (PET).

In some variants, the hole wipe 10 comprises multiple layers. For example, the hole wipe 10 can include a barrier layer (e.g., a layer of latex, nitrile rubber, polyvinyl chloride, and/or neoprene) and a layer of absorbent material. This can provide a barrier between the user's finger and the inner surface of the hole and provide a substrate that can dispense the antimicrobial agent. The barrier layer can be positioned radially inward of the absorbent layer and/or nearer to the wearer's finger than the absorbent layer.

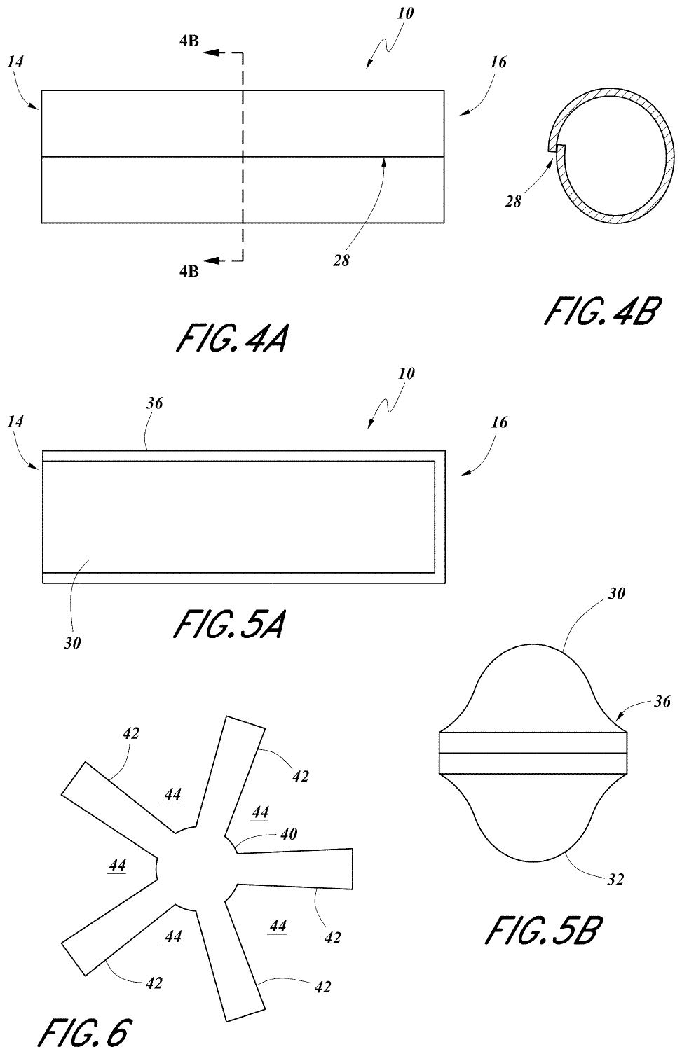

### FIGS. 3A and 3B

FIGS. 3A and 3B illustrate another embodiment of the hole wipe 10. FIG. 3A is a side view of the hole wipe 10 and FIG. 3B is a front view of the hole wipe 10. As shown, the closed end 16 of the hole wipe 10 can be rounded and/or tapered. The closed end 16 can terminate at a flat or rounded tip. The closed end 16 can be generally continuous and/or uninterrupted. For example, as shown, some embodiments of the hole wipe 10 does not include the seam 20 and/or the closed end 16 is uninterrupted.

In some variants, the open end 14 comprises an insertion aid, such as a convex region or flap 22. The flap 22 can have a free end, such as an end closer to the open end 14 than the closed end 16 of the wipe 10. The flap 22 can help a user in inserting his or her finger into the hole wipe 10. For example, the user can grasp the flap 22 to open the hole wipe 10. In some embodiments, the insertion aid comprises a tab 22a that extends from the open end 14. In various embodiments, the flap 22 and/or tab 22a can provide an area for the user to grasp to pull the hole wipe 10 onto the finger. In some implementations, the insertion aid can help a user in removing the hole wipe 10 from the finger. For example, after use, the user can grasp the flap 22 and/or tab 22a and readily pull the hole wipe 10 off of the finger. In certain variants, the tab 22a extends to the base of a user's finger and/or into the user's palm. The flap 22 and/or tab 22a can be straight, curved, or otherwise shaped (e.g., triangular).

The hole wipe 10 can include a securing mechanism, which can act to maintain the hole wipe 10 on the user's finger. This can reduce the chance of the hole wipe 10 falling off of the user's finger while in the hole of the bowling ball, which could be inconvenient to retrieve from and/or could expose the user's finger to untreated surfaces in the hole. As shown, in some embodiments, an elastic ring 24 is located on or near the open end 14. When the user's finger is inserted into the hole wipe 10, the elastic ring 24 expands, thereby applying a pressure around the finger which secures the hole wipe 10 to the finger. In some variants, the securing mechanism comprises a string, bendable wire, cinch, tab, or otherwise.

Some embodiments have a retrieval feature, which can aid in recovering the hole wipe 10 should it fall down into the hole. For example, the hole wipe 10 can be sized to be longer than the depth of the hole, such as being at least 2.5 inches long or at least 3.5 inches long. In some variants, the hole wipe 10 has a string or other elongate member that is connected to the body 12 and is maintained outside the hole. Were the body 12 of the hole wipe 10 to fall into the hole, the user can pull on the string to retrieve it.

### FIGS. 4A and 4B

FIGS. 4A and 4B show another embodiment of the hole wipe 10. FIG. 4A illustrates a side view and FIG. 4B illustrates a cross-section along the line 4B-4B. In some implementations, the hole wipe 10 is formed from a sheet of material that is rolled into a tubular element. The edges of the sheet can be abutted or overlapped, which forms a longitudinal seam 28. The edges can be joined, such as with adhesive, pressing, stitching, heating, or welding, etc. In some embodiments, during manufacture the tubular element is made at a length much greater than the length that would be appropriate for the hole wipe 10. This long tubular element can be cut at various locations along its longitudinal length, such as to create individual lengths appropriate for the hole wipe 10. An end of each of the individual lengths can be joined, such as with adhesive, pressing, stitching, heating or welding, etc. The joining can form the closed end 16 and/or the seam 20. An opposing end of the wipe 10 can be cut to form the open end 14.

### FIGS. 5A and 5B

FIGS. 5A and 5B show another embodiment of the hole wipe 10. FIG. 5A illustrates a side view of the hole wipe 10 and FIG. 4B illustrates a front view of the hole wipe 10. The hole wipe 10 can include a first layer 30 and a second layer 32. The layers 30, 32 can each be cut to size and shape from one or more sheets of material. The layers can be joined at an interface (e.g., with adhesive, pressing, stitching, heating or welding, etc.), such as on sides and on an end 16 as illustrated. One end can be left unjoined to be the open end 14.

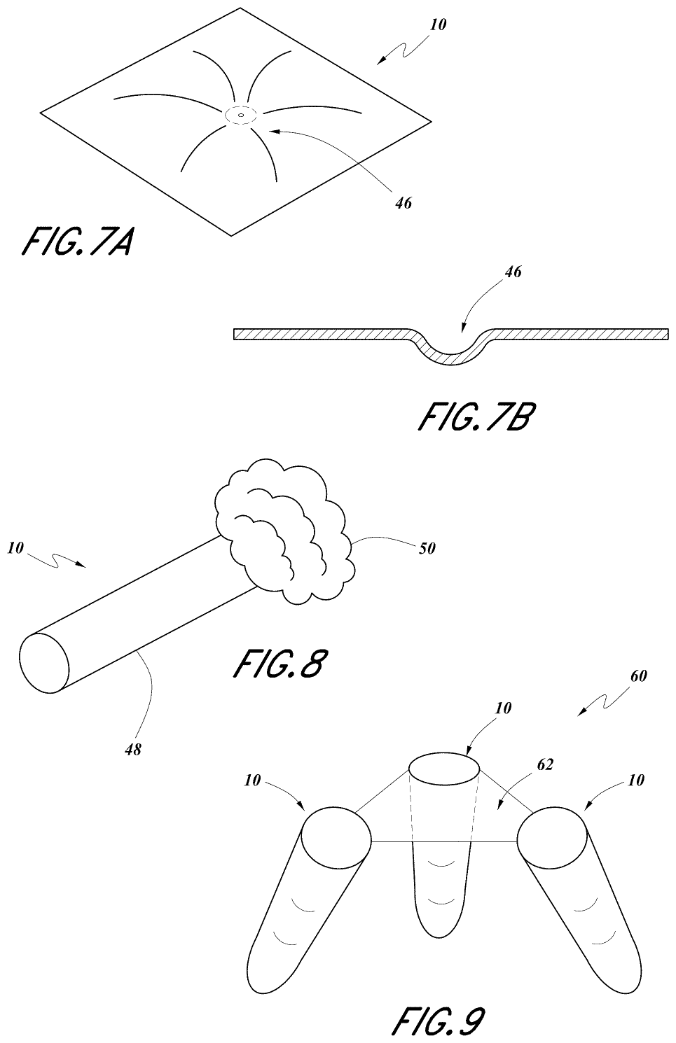

### FIG. 6

FIG. 6 illustrates another embodiment of the hole wipe 10. The hole wipe 10 can comprise a generally flat sheet that is configured for insertion into a finger hole. The hole wipe 10 can include a hub 40 that is connected to a plurality of arms 42, such as 3, 4, 5, 6, 7, 8, or more arms. The hub 40 can be centrally located. The hub 40 can be circular or other shapes.

The arms can be separated from each other by a gap 44. A user can place his or her fingertip in the hub 40 and push the hub 40 into the hole. At least some of the arms 42 can be drawn into the hole as well, which moves the arms 42 closer to each other. Advantageously, the gap 44 can provide space for such movement of the arms 42, which can avoid the bunching problem that often occurs when trying to insert a flat sheet of material without such gaps (e.g., a rectangular flat sheet) into the hole. In certain variants, in place of or in addition to the gap 44, the wipe 10 includes one or more regions that are configured to fold, such as creases or crimps. When the wipe 10 is inserted into the hole, the wipe 10 can be configured to fold along the creases, thereby reducing or avoiding the bunching problem. In some embodiments, the gaps 44 comprises one or more slits in the wipe 10. For example, the wipe 10 can include slits or other open space. The slits can be configured to inhibit bunching of the wipe 10 when pushed into a hole. The slits can have a linear, curved, or other shape (e.g., spiral). In certain variants, the slits extend radially outward from the hub 40. The slits can extend partially or completely to an outer perimeter of the wipe 10.

The hole wipe 10 can be rolled, folded, or otherwise reduced in size in packaging. The hub 40 can include a concavity, which can receive the user's fingertip. This can aid in centering the fingertip in the wipe 10, can aid in maintaining the wipe 10 on the fingertip, or otherwise.

### FIGS. 7A and 7B

FIGS. 7A and 7B illustrate still another variant of the hole wipe 10. FIG. 7A is a perspective view of the hole wipe 10 and FIG. 7B is a cross-sectional view of the hole wipe 10. As shown, the hole wipe 10 can comprise a sheet of material, such as a flat sheet. The wipe 10 can include an indentation 46. The indentation 46 can permit the hole wipe 10 to be inserted to the bottom of the hole. For example, the indentation 46 can reduce the amount of surrounding (e.g., non-indented) material of the wipe 10 that needs to be drawn into the hole in order to reach the bottom of the hole. This can reduce or avoid bunching of the wipe 10. The hole wipe 10 can be rolled, folded, or otherwise reduced in size in packaging.

### FIG. 8

FIG. 8 illustrates another embodiment of the hole wipe 10. The hole wipe 10 can comprise a wipe stick that includes a handle 48 connected to a bulbous end 50. The handle 48 can be a generally tubular member and/or can be generally rigid. For example, the handle 48 can be a wooden, paper, cardboard, or plastic stick. The bulbous end 50 can be made of the absorbent material and can include the antimicrobial or otherwise cleaning agent. A user can grasp the handle 48 and insert the bulbous end 50 into the hole. The user can manipulate the handle 48 to move the hole wipe 10 within the hole. In some embodiments, the bulbous end 50 is larger than the diameter of a bowling ball hole and/or is configured to compress within the hole. This can ensure contact between the bulbous end 50 (and the antimicrobial agent( ) and the inner surface of the hole. In certain implementations, the handle 48 is configured to clean the sides of the hole. For example, the handle 48 includes the antimicrobial or otherwise cleaning agent. In certain implementations, the diameter of the handle 48 is approximately the diameter of the hole, such as greater than or equal to about: ⅜ inch, ½ inch, ⅝ inch, ¾ inch, ⅞ inch, or otherwise. In some embodiments, the handle 48 is a slip fit or an interference fit with the hole.

### FIG. 9

FIG. 9 illustrates a unit 60 comprising multiple hole wipes 10. As shown, the unit 60 can include three of the wipes 10, which corresponds to the number of finger holes in a typical rental bowling ball. Other implementations include other numbers of wipes, such as two, four, or more. The wipes 10 can be connected, such as with a body 62 as illustrated. The body 62 can comprise a sheet of material, such as the same material that the wipes 10 are made of. In some implementations, the wipes 10 and body 62 are unitarily formed. The body 62 can be flat. The body 62 can be elastic. In some variants, the body 62 comprises a string or other elongate member. The body 62 can be configured to be maintained outside the holes when the wipes 10 are inserted into the holes and/or can be configured to abut with the outer surface of the bowling ball.

In some variations, the unit 60 is configured to be maintained in the bowling ball during a period of non-use (e.g., storage) and removed for use of the ball. This can seal the bowling ball holes, can inhibit airborne contamination of the holes during non-use, and/or can act as an indicator (e.g., of which bowling balls have been recently used and/or have not been cleaned).

### Additional Aspects

Various processes can be used to manufacture the hole wipe 10. For example, as discussed above, a rolling and joining method can be used. In certain implementations, the hole wipe 10 is extruded. In some embodiments, the hole wipe 10 is constructed from layers of cut (e.g., punched) and joined material.

The hole wipe 10 can be packaged, such as to maintain cleanliness and/or the potency of the antimicrobial agent. For example, the hole wipe 10 can be in a sealed plastic or foil-lined package. The hole wipe 10 can be individually packaged, such as in an individual tear pouch. The hole wipe 10 can be bulk packaged and configured for individual dispensation. For example, multiple hole wipes 10 can be packaged in a roll, interfolded, or otherwise configured for dispensing in series one-at-a-time. The multiple wipes 10 can be housed in a package, such as a box made of a cardboard or another material. In some embodiments, a leading one of the multiple wipes 10 protrudes out of the package. A user can grasp and pull the leading wipe 10, thereby extracting the leading wipe 10 and placing another wipe in the leading wipe position. In certain embodiments, the leading wipe 10 is visible protruding out of the package.

The hole wipe 10 can be included in a kit, such as a bowling ball rental kit. The kit can include one or more of the wipes 10. The kit can include bowling shoes. The kit can include a bowling ball. The kit can be held in a bag, box, or other container. When a user rents a lane in a bowling alley, the user can be issued the kit to enable the user to clean the bowling ball. The wipes 10 can be issued as packaged units (e.g., individually packaged units) or unpackaged. In some embodiments, the kit comprises at least three wipes, which is enough for one wipe for each of the finger holes in a typical rental bowling ball.

### Certain Terminology

As used herein, terms of orientation, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees and the term “generally perpendicular” can refer to something that departs from exactly perpendicular by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### SUMMARY

The wipes for blind holes technology of the present disclosure has been discussed in the context of certain embodiments and examples. The technology extends beyond the specifically disclosed embodiments to other alternative embodiments and/or uses of the embodiments and certain modifications and equivalents thereof. For example, although certain embodiments are disclosed in the context of a bowling ball blind hole, the technology can be applied to sanitizing and/or disinfecting other types of blind holes. As another example, while some embodiments have been shown in the context of a hole wipe that fits on and/or covers one finger, some variants fit on and/or cover multiple fingers and/or are in the form of a glove. Any two or more of the components of the dispenser system can be made from a single monolithic piece or from separate pieces connected together. Various features and aspects of the disclosed embodiments can be combined with or substituted for one another in order to form varying modes of the invention. The scope of this disclosure should not be limited by the particular disclosed embodiments described herein.

Certain features that are described in this disclosure in the context of separate implementations can also be implemented in combination in a single implementation. Conversely, various features that are described in the context of a single implementation can also be implemented in multiple implementations separately or in any suitable subcombination. Although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying drawings. The figures are drawn to scale, but such scale is not limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

In summary, various embodiments and examples of hole wipes and related methods have been disclosed. Although the hole wipes have been disclosed in the context of those embodiments and examples, the technology of this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another.

The following is claimed:

1. An antimicrobial bowling ball hole wipe that comprises:
a body comprising:
a first side
a second side opposite the first side;
an open end; and
a closed end opposite the open end; and
an antimicrobial agent;
wherein the hole wipe is configured to be inserted on a user's finger and to be inserted into a blind hold of a bowling ball, thereby enabling a bottom surface of the hole to be cleaned of microbes.

2. The antimicrobial bowling ball hole wipe of claim 1, wherein the antimicrobial agent comprises at least 70% alcohol.

3. The antimicrobial bowling ball hole wipe of claim 1, wherein the antimicrobial agent comprises bleach.

4. The antimicrobial bowling ball hole wipe of claim 1, wherein the first side comprises an insertion aid comprising a recess adjacent the open end.

5. The antimicrobial bowling ball hole wipe of claim 1, wherein the first side comprises an insertion aid comprising a flap having a free end.

6. The antimicrobial bowling ball hole wipe of claim 1, further comprising an insertion and removal tab that extends from the open end.

7. The antimicrobial bowling ball hole wipe of claim 1, wherein the body comprises a material configured to absorb the antimicrobial agent.

8. The antimicrobial bowling ball hole wipe of claim 7, wherein the material comprises cotton.

9. The antimicrobial bowling ball hole wipe of claim 1, further comprising an elastic ring adjacent the open end.

10. The antimicrobial bowling ball hole wipe of claim 1, further comprising a seam on the closed end.

11. The antimicrobial bowling ball hole wipe of claim 1, wherein the body comprises a longitudinal seam from the open end to the closed end.

12. The antimicrobial bowling ball hole wipe of claim 1, wherein first side and the second side are joined along a top and a bottom and along the closed end.

13. The antimicrobial bowling ball hole wipe of claim 1, wherein the antimicrobial bowling ball hole wipe is individually packaged in an outer tear pouch.

14. The antimicrobial bowling ball hole wipe of claim 1, wherein the body comprises a barrier layer and an absorbent layer.

15. A kit comprising the antimicrobial bowling ball hole wipe of claim 1 and a pair of bowling shoes.

16. An antimicrobial bowling ball hole wipe that comprises:
a flat sheet comprising:
a central hub;
a plurality of arms connected to the central hub and extending radially outward from the central hub; and
a plurality of gaps, wherein each of the plurality of gaps are located between respective circumferentially-adjacent arms of the plurality of arms; and
an antimicrobial agent;
wherein the hole wipe is configured to be inserted on a user's finger and to be inserted into a blind hold of a bowling ball.

17. The antimicrobial bowling ball hole wipe of claim 16, wherein the hub comprises a concavity configured to receive a tip of the finger.

18. The antimicrobial bowling ball hole wipe of claim 16, wherein the antimicrobial agent comprises at least 70% alcohol.

19. A method of manufacturing an antimicrobial bowling ball hole wipe, the method comprising:
rolling a flat sheet of material into a tubular element in which a first lateral edge overlaps a second lateral edge;
cutting the tubular element into a plurality of tubes;
closing a first end of each of the plurality of tubes;
keeping open a second end of each of the plurality of tubes, the second end opposite the first end; and
applying an antimicrobial agent to each of the plurality of tubes.

20. The method of manufacturing of claim 19, further comprising individually packaging each of the plurality of tubes.
